(19) United States
(12) Patent Application Publication
(10) Pub. No.: US 2024/0305090 A1
(43) Pub. Date: Sep. 12, 2024

(54) METHOD AND SYSTEM FOR PROTECTING AN ELECTRICAL DISTRIBUTION NETWORK COMPRISING AT LEAST TWO SOURCES OF ELECTRICAL ENERGY

(71) Applicant: Schneider Electric Industries SAS, Rueil Malmaison (FR)

(72) Inventors: Denis Dodelin, Grenoble (FR); Patrick Perron, Moirans (FR)

(73) Assignee: Schneider Electric Industries SAS, Rueil Malmaison (FR)

(21) Appl. No.: 18/581,521

(22) Filed: Feb. 20, 2024

(30) Foreign Application Priority Data
Mar. 7, 2023 (FR) 2302094

(51) Int. Cl. H02H 7/26

(52) U.S. Cl. CPC H02H 7/261

(57) ABSTRACT

A method and a system for protecting an electrical distribution network, the system including sources of electrical energy, loads and protection devices, each having a nominal trip timer and being configured to supply signals of detection of the presence and direction of a fault current. The system determines monitoring points and a fault condition associated with each monitoring point directly connected to several protection devices, defined by rules relating to the presence and the direction of the fault current detected by each protection device in the vicinity of the monitoring point, and, when a fault condition is confirmed, trips as a priority, with a trip timer less than the nominal trip timer, the opening of at least one of the monitoring devices in the vicinity of the fault point.

### TECHNICAL FIELD

The present invention relates to a method and a system for protecting an electrical distribution network comprising at least two sources of electrical energy.

The invention falls into the general field of the protection of electrical installations, and more particularly into the field of the tripping of the protection devices in electrical installations, e.g. complex electrical energy distribution networks.

### BACKGROUND

Such electrical energy distribution networks are for example dedicated to a building, for domestic or professional use; these are for example autonomous electrical networks.

The case is in particular considered of multi-source and multi-load electrical energy distribution networks, the sources of electrical energy being set up for supplying electricity to the loads in various situations, where the flow of current may be bidirectional, in other words in both a first direction of flow from the sources towards the loads, and in a second direction of flow from the loads towards the sources.

For example, the sources of electrical energy comprise generators, transformers, some of the sources being for example relief sources, set up for supplying electrical energy and ensuring the continuity of supply of the electrical energy in the case of failure of one or more main sources of electrical energy.

Such electrical energy distribution network is set up for supplying any given number of loads, for example by means of several connection bars or current distributors. In a known manner, protection devices, also called circuit breakers, are connected between the sources and the loads in order to protect the whole of the network in the case of the presence of a fault, notably in the presence of a current of higher intensity then a fault current threshold.

The protection is indispensable in order to preserve the various pieces of equipment (sources and loads), and also in order to avoid safety risks such as causing a fire for example.

The protection devices are, in a known manner, set up for supplying a signal of detection of a fault current indicating the presence or the absence of a fault detected on an associated conductor, depending on a current amplitude, and an indication of the direction of the fault current.

One of the problems posed in an electrical energy distribution network of the type described hereinabove is the judicious tripping of the protection devices in order to interrupt the flow of electrical current, in other words going from a closed state to an open state, while avoiding an unnecessary power supply interruption for a part of the network. Indeed, in a complex architecture of the connections between the plurality of sources and of loads, the detection of a fault current may occur simultaneously within several protection devices, whereas the tripping of all the protection devices is unnecessary. Moreover, the unnecessary tripping of certain protection devices leads to a power cut in parts of the electrical distribution network which are not at fault, and a maintenance intervention in order to restore the operation which could be avoided.

Accordingly, there exists a need for selecting or for prioritizing the tripping of the protection device to be tripped in such a complex connection architecture, allowing selective interruptions to be carried out within a limited interval of time after detection of a fault, for example within a limit of 200 ms.

### SUMMARY

For this purpose, according to one aspect, the invention provides a method for protecting an electrical distribution network comprising at least two sources of electrical energy, at least two connection bars, a plurality of loads to be supplied being respectively connected to one or the other of the connection bars, protection devices being connected on at least one electrical conductor between the sources and the loads, the electrical current flowing in either a first direction of current flow from the sources towards the loads, or in a second direction of current flow from the loads towards the sources, each protection device being set up so as to go from a closed state to and open state, the flow of electrical current in said at least one conductor being interrupted when the protection device is in the open state, each protection device having a nominal trip timer and being furthermore set up for supplying a signal of detection of a fault current indicating the presence or absence of a fault detected on an associated conductor depending on a current amplitude, and an indication of the direction of the fault current.

This method comprises:
the determination of a plurality of monitoring points within the distribution network, comprising at least one monitoring point connected directly to a plurality of protection devices, forming a vicinity of said monitoring point,
for each monitoring point, the determination of an associated fault condition, said fault condition being defined by a plurality of rules relating to the signals indicating the presence or absence of a fault and the associated indication of direction of the current for each protection device in the vicinity of said monitoring point,
the monitoring of a confirmation of a fault condition, and when a fault condition associated with a monitoring point is confirmed, tripping as a priority, with a trip timer less than the nominal trip timer, of the opening of at least one of the devices for monitoring the vicinity of said fault point.

Advantageously, the method provided allows a protection to be implemented by selective tripping according to rules relating to the fault detection signals supplied by a plurality of protection devices. Advantageously, the state of a plurality of conductors connected to sources and/or to loads is taken into consideration in order to optimize the selective interruption.

The method for protecting an electrical distribution network according to the invention may exhibit one or more of the features hereinbelow, taken independently or according to all the acceptable combinations.

When the fault condition associated with a monitoring point is confirmed, all the protection devices in the vicinity of said monitoring point which supply said monitoring point with current are tripped as a priority.

The rules are implemented in the form of hard-wired logic, in such a manner as to trip said at least one protection device forming part of the vicinity of a monitoring point when all of the rules forming the fault condition associated with said monitoring point are confirmed.

For a monitoring point, at least one rule associated with a protection device in the vicinity combines the presence of a detected fault with an associated fault direction or the absence of a detected fault.

The absence of a detected fault is also representative of a state of opening of said protection device.

For each monitoring point, the associated fault condition is defined by the following cumulative rules: for each of the protection devices in the vicinity of said monitoring point, there is either: the detection of the presence of a fault, the direction of the fault current being in the direction of said monitoring point or the absence of a fault detection.

According to another aspect, the invention relates to a system for protecting an electrical distribution network comprising at least two sources of electrical energy, at least two connection bars, a plurality of loads to be supplied being respectively connected to one or the other of the connection bars, protection devices being connected on at least one electrical conductor between the sources and the loads, the electrical current flowing either in a first direction of flow of the current from the sources towards the loads, or in a second direction of current flow from the loads towards the sources, each protection device being set up so as to go from a closed state to and open state, the flow of electrical current in said at least one conductor being interrupted when the protection device is in the open state, each protection device having a nominal trip timer and being furthermore set up for supplying a signal of detection of a fault current indicating the presence or the absence of a fault detected on an associated conductor depending on a current amplitude, and an indication of the direction of the fault current.

This system being set up for:
determining a plurality of monitoring points within the distribution network, comprising at least one monitoring point directly connected to a plurality of protection devices, forming a vicinity of said monitoring point,
for each monitoring point, determining an associated fault condition, said fault condition being defined by a plurality of rules relating to the signals indicating the presence or absence of a fault and the associated indication of direction of the current of each protection device in the vicinity of said monitoring point,
monitoring a confirmation of a fault condition, and when a fault condition associated with a monitoring point is confirmed, tripping as a priority, with a trip timer less than the nominal trip timer, the opening of at least one of the devices for monitoring the vicinity of said fault point.

The system offers the advantages of the method for protecting an electrical distribution network such as briefly described hereinabove.

The system for protecting an electrical distribution network according to the invention may exhibit one or more of the features hereinbelow, taken independently or according to all the acceptable combinations.

The monitoring of confirmation of a fault condition is effected by a hard-wired logic, each protection device being set up for verifying one or more fault conditions, each fault condition being associated with a monitoring point of the vicinity to which said protection device belongs.

Each given protection device, belonging to a vicinity of a monitoring point, receives at the input, via connection cables, the signals indicative of the presence of a fault current and indicative of the direction of the current of each other protection device belonging to said vicinity of said monitoring point, each of said signals being a binary signal.

In each protection device, the confirmation of the fault condition associated with said monitoring point is implemented, based on the binary signals received at the input, by means of internal relays of the protection device.

In each protection device, the confirmation of the fault condition associated with said monitoring point is implemented by logic gates.

### BRIEF DESCRIPTION OF THE DRAWINGS

Other features and advantages of the invention will become apparent from the description of it given hereinbelow, by way of non-limiting example, with reference to the appended figures, amongst which:

FIG. 1 shows schematically an electrical distribution network in which the protection system according to the invention is implemented;

FIG. 2 shows schematically the electrical distribution network in FIG. 1 enhanced with devices forming part of the protection system;

FIG. 3 is a flow diagram of a protection method according to one embodiment.

### DETAILED DESCRIPTION

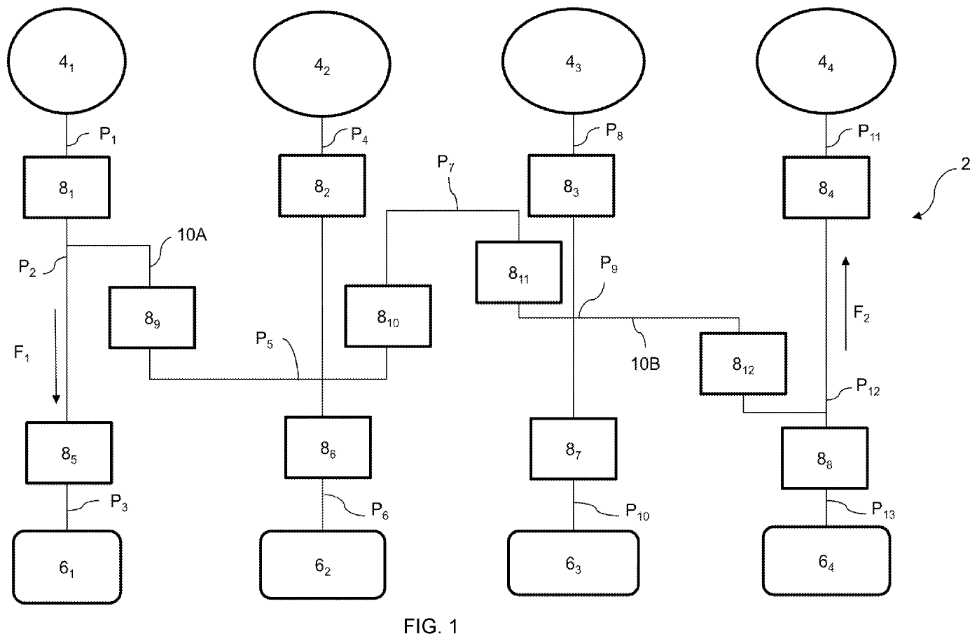

FIG. 1 shows schematically an electrical distribution network 2, described by way of non-limiting example.

The network 2 comprises sources of electrical energy denoted by the general reference 4, for example generators, respectively referenced 4₁, 4₂, 4₃, 4₄, and a plurality of loads denoted by the general reference 6, referenced 6₁, 6₂, 6₃, 6₄ in FIG. 1.

Generally speaking, the invention is applicable with 2 or more sources of electrical energy.

In a simplified manner, only four loads are shown, but of course any given number of loads may be considered, where the number of loads supplied by one of the sources does not change the implementation of the protection method and of the protection system described hereinafter.

The network 2 also comprises protection devices, also referred to as circuit breakers denoted by the general reference 8, which are 12 in number in the example illustrated, referenced 8₁ to 8₁₂, respectively connected between the sources and the loads, on various electrical conductors 10 of the installation, which are on bars of conductors 10A, 10B in the example in FIG. 1. Thus, the electrical distribution network 2 is formed of 2 sub-networks in this example.

The electrical conductors have been shown schematically by a single line. It is understood that the protection system is applicable for an electrical distribution network with N phases, for example in particular for the single-phase or three-phase case, with or without a neutral conductor. The number of phase conductors is of course adapted accordingly, the connection of the various devices being adapted as a consequence.

In particular, by way of example, the protection system is applicable in the case of balanced three-phase generators 4₁, 4₂, 4₃, 4₄, supplying voltage and current electrical signals out of phase by 30°, for an r.m.s. voltage of 690V.

The protection devices are referenced from 1 to 12 in order to differentiate them in the explanation.

In one embodiment, the protection devices are of the same type.

For example, in one embodiment, the protection devices are products of the MasterPacT MTZ® type from Schneider Electric.

In the electricity distribution network 2, the current is flowing in a first direction, indicated by the arrow F1, from the sources towards the loads. In the case of a fault, a flow of the electrical current in a second direction, indicated by the arrow F2, is observed.

In practice, the terminology forward direction for the first direction indicated by the arrow F1 and reverse direction for the second direction indicated by the arrow F2 is also used.

Each protection device 8 is set up so as to go from a closed state (in which the current flows in the associated conductor 10) to an open state (in which the flow of current in the associated conductor 10 is interrupted), for example upon a command or upon confirmation of a condition, which notably depends on the intensity of the current. The passage from the closed state to the open state is also called tripping of the protection device.

Each protection device 8 is set up so as to supply a signal of detection of a fault current indicating the presence of a fault on an electrical conductor to which it is connected, and an indication of the direction of the fault current (i.e. forward direction or reverse direction).

In addition, each protection device is set up, in its nominal operation, to open in order to interrupt the flow of the electrical current after the expiration of a nominal trip timer T₀, for example equal to 300 ms, following the detection of the presence of a fault current.

In one embodiment, each protection device 8 is set up for supplying three binary signals (or “all or nothing” signals, able to take two values): a first binary signal indicating the presence of a fault current, a second binary signal indicating the presence of a fault in the first direction (or forward direction), and a third binary signal indicating the presence of a fault in the second direction (or reverse direction).

A plurality of points P₁ to P₁₃, referred to as fault monitoring points, are determined in order to provide the monitoring of the occurrence of faults and the selective protection within the distribution network 2.

The monitoring points within the distribution network are categorized in three groups:
A first group of points on the electrical conductors situated between a source 4 and a protection device 8: P₁, P₄, P₈, P₁₁;
A second group of points on the electrical conductors situated between a load 6 and a protection device 8: P₃, P₆, P₁₀, P₁₃;
A third group of points on the electrical conductors situated between two or more protection devices: P₂, P₅, P₇, P₉ and P₁₂. In other words, these are interconnection points.

The monitoring points of the third group listed hereinabove are such that each is directly connected to several protection devices 8, which form a vicinity of this monitoring point.

For example, in the embodiment in FIG. 1:
for the point P₂, the vicinity is formed from the protection devices 8₁; 8₅; 8₉;
for the point P₅, the vicinity is formed from the protection devices 8₂; 8₆; 8₉ and 8₁₀;
for the point P₇, the vicinity is formed from the protection devices 8₁₀ and 8₁₁;
for the point P₉, the vicinity is formed from the protection devices 8₃; 8₇; 8₁₁ and 8₁₂;
for the point P₁₂, the vicinity is formed from the protection devices 8₄; 8₈; 8₁₂.

The monitoring points are points where an electrical fault may appear. They depend on the connection architecture of the network 2.

The protection system provided includes a determination of the presence of faults at the monitoring points, and, in the case of detection of the presence of a fault, the tripping as a priority of at least one associated protection device which is one of the protection devices in the vicinity of the monitoring point.

Tripping as a priority is understood to mean a faster tripping than the duration of the nominal timer T₀.

In one embodiment, all the protection devices in the vicinity of the monitoring point which supply the fault at the monitoring point are tripped.

Advantageously, the faster tripping (or as a priority) of these protection devices allows the fault to be eliminated, hence the fault detection on other protection devices of the electricity distribution network to be modified. This allows unnecessary trippings of protection devices, hence an unnecessary electrical power cut in some parts of the network to be avoided.

In order to determine the presence of a fault at a monitoring point, a fault condition is associated.

The fault condition is a multi-rule condition which implements a plurality of rules relating to the signals supplied by the protection devices of the vicinity.

In the electrical distribution network 2, in the case of the occurrence of a fault at the monitoring points of the first group of points P₁, P₄, P₈, P₁₁, the implementation (e.g. the tripping) of the associated protection devices 8₁, 8₂, 8₃ and 8₄ is recommended.

In the electrical distribution network 2, in the case of the occurrence of a fault at the monitoring points of the second group of points P₃, P₆, P₁₀, P₁₃, the implementation (e.g. the tripping) of the associated protection devices 8₅, 8₆, 8₇ and 8₈ is recommended.

For the monitoring points of the third group, which are interconnection points, connected to at least two protection devices, the fault condition implements a plurality of rules relating to the fault detection for the protection devices of the vicinity.

The rules are cumulative, in other words the fault condition is only confirmed if all the rules are verified.

Advantageously, in addition to the detection of the presence of a fault by one of the protection devices, the absence of fault detection is also used in the rules. This notably allows the case to be automatically handled where a part of the sources 4₁ to 4₄, for example a generator, is in the OFF state or if the protection device is in the open state.

The absence of fault detection corresponds to a fault detection signal at zero, for example the first binary signal is at zero in the embodiment of the protection devices described hereinabove.

For each monitoring point, the fault condition is defined by cumulative rules: for each of the protection devices in the vicinity of the monitoring point, there is either: the detection of the presence of a fault, in the direction going towards the monitoring point, or the absence of fault detection.

By way of example, in the distribution network 2 illustrated:

Fault condition C1 associated with P₂:
C11)—protection device 8₁: presence of a fault in the direction 1 or absence of fault detection;
C12)—protection device 8₉: presence of a fault in the direction 2 or absence of fault detection;
C13)—protection device 8₅: absence of fault detection.

In the case where the fault condition at P₂ is confirmed, the priority tripping (e.g. the opening) of the protection devices 8₁ and 8₉, when they detect the presence of a fault, is commanded with a trip timer less than the nominal timer, or even equal to zero. In other words, the trip timer, initially fixed at the nominal value T₀, is reduced, for example to zero, for an immediate tripping.

Thus, the mechanism provided accelerates the opening of the protection devices depending on the confirmation of the fault condition.

It should be noted that the rule C13) might not be implemented in some embodiments. Indeed, if a fault is detected by the protection device 8₅, since it is necessary to protect the associated load 6₁, the tripping of this device is virtually immediate, with a short trip timer, for example equal to zero. Thus, a tripping, hence an interruption, occurs before the implementation of the rules hereinabove at the monitoring point P₂.

In an analogous manner, for the distribution network 2 illustrated:

Fault condition C2 associated with P₅:
C21)—protection device 8₂: presence of a fault in the direction 1 or absence of fault detection;
C22)—protection device 8₉: presence of a fault in the direction 1 or absence of fault detection;
C23)—protection device 8₁₀: presence of a fault in the direction 1 or absence of fault detection;
C24) protection device 8₆: absence of fault detection.

In the case where the fault condition at P₅ is confirmed, the priority tripping (e.g. the opening) of the protection devices 8₂, 8₉ and 8₁₀, when they detect the presence of a fault, is commanded with a trip timer less than the nominal timer, or even equal to zero.

Fault condition C3 associated with P₇:
C31)—protection device 8₁₀: presence of a fault in the direction 2 or absence of fault detection;
C32)—protection device 8₁₁: presence of a fault in the direction 2 or absence of fault detection;

In the case where the fault condition at P₇ is confirmed, the priority tripping (e.g. the opening) of the protection devices 8₁₀ and 8₁₁, when they detect the presence of a fault, is commanded with a trip timer less than the nominal timer, or even equal to zero.

Fault condition C4 associated with P₉:
C41)—protection device 8₃: presence of a fault in the direction 1 or absence of fault detection;
C42)—protection device 8₁₁: presence of a fault in the direction 1 or absence of fault detection;
C43)—protection device 8₁₂: presence of a fault in the direction 2 or absence of fault detection;
C44) protection device 8₇: absence of fault detection.

In the case where the fault condition at P₉ is confirmed, the priority tripping (e.g. the opening) of the protection devices 8₃, 8₁₁ and 8₁₂, when they detect the presence of a fault, is commanded with a trip timer less than the nominal timer, or even equal to zero.

Fault condition C5 associated with P₁₂:
C51)—protection device 8₄: presence of a fault in the direction 1 or absence of fault detection;
C52)—protection device 8₁₂: presence of a fault in the direction 1 or absence of fault detection;
C53) protection device 8₈: absence of fault detection.

In the case where the fault condition at P₁₂ is confirmed, the priority tripping (e.g. the opening) of the protection devices 8₄ and 8₁₂, when they detect the presence of a fault, is commanded with a trip timer less than the nominal timer, or even equal to zero.

Advantageously, when a fault condition associated with a monitoring point is confirmed, the fast tripping of the protection devices of the vicinity eliminates the presence of a fault, and hence other protection devices, which also detect the presence of a fault, do not trip.

Moreover, the prioritized tripping of one of the protection devices allows the fault condition to be eliminated, and hence the tripping of the other protection devices to be avoided.

For example, when the fault condition C1 is confirmed, the fast tripping, within the tripping period, of the device 8₉ will allow the tripping of the device 8₂. In the absence of the mechanism provided, the protection device 8₂ would also be tripped.

It should also be noted that safety remains assured because the nominal trip timer T₀ remains applicable, if a fault is detected during this period.

The fault conditions associated with the given monitoring points are implemented by one or more devices, in such a manner as to ensure the selective tripping of the protection devices depending on the confirmation of the fault conditions.

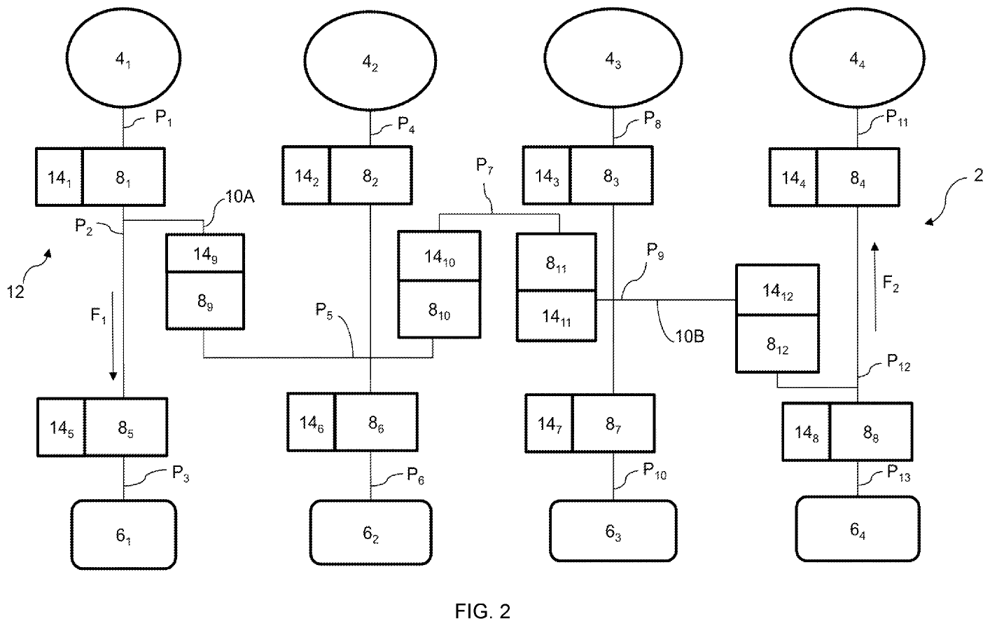

In one embodiment, illustrated in FIG. 2, a protection system 12 is formed by the implementation of the multi-rule fault conditions associated with each monitoring point of the distribution network 2 via wiring between the protection devices 8, allowing, within each protection device, the multi-rule fault condition or conditions to be implemented, by hard-wired logic, for each monitoring point of the vicinity to which the protection device belongs.

For example, the protection device 8₉ is in the vicinity of the monitoring point P₂ and also in the vicinity of the monitoring point P₅, hence, via the hard-wired logic, the fault conditions C1 and C2 are verified by the protection device 8₉.

In practice, in order to verify a fault condition associated with a monitoring point, for each given protection device, belonging to the vicinity of the monitoring point, the binary signals indicative of the presence of a fault current and indicative of the direction of the current of each other protection device belonging to the vicinity of the monitoring point are brought, by hard-wired logic, to the input of said given protection device.

Optionally, devices 14 are associated with the protection devices 8 and set up for implementing the fault conditions in cooperation with the protection devices 8.

The devices 14 are for example interface modules of the protection devices, also known by the name RIM (restraint interface module) modules, which allows an electrical isolation to be provided for the implementation of several fault conditions.

In addition, wired relays inside of each protection device are also used for the implementation of the rules of the given fault conditions.

Thus, each protection device is set up for verifying one or more fault conditions, each fault condition being associated with a monitoring point to the vicinity of which the protection device belongs. As soon as a fault condition is confirmed, the trip timer is modified, for example set to zero.

Advantageously, the use of relays and of interface modules guarantee the electrical isolation and the speed of operation.

As a variant, not shown, other embodiments may be envisaged, for example by means of logic gates.

According to another variant, not shown, a dedicated electronic card, comprising a processor, is used for programming the verification of the given multi-rule fault conditions, then, in the case of determination of a fault at a monitoring point, controlling the priority tripping, fast or immediate, with a trip timer T₁ less than the nominal timer T₀, of the protection devices depending on the monitoring point at fault.

In this case, a synchronisation is implemented so as to ensure the tripping after verification of the multi-rule fault conditions, given that the information relating to the detection of a fault are transmitted asynchronously.

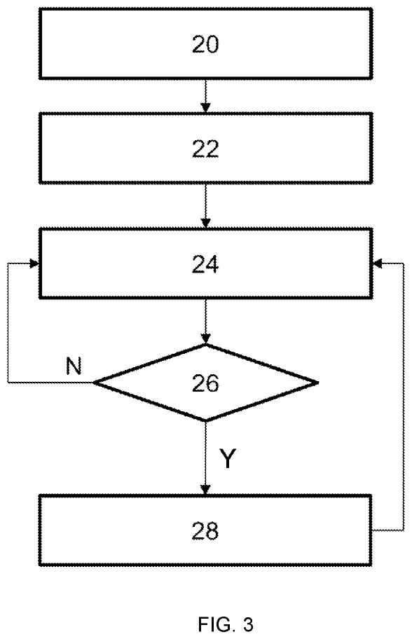

FIG. 3 illustrates schematically the main steps of a method for protecting an electrical distribution network according to one embodiment.

The method comprises a step 20 for determining a plurality of monitoring points within the distribution network, the monitoring points being interconnection points, each monitoring point being connected to at least two protection devices.

The method also comprises a step 22 for determining an associated fault condition, said fault condition being defined by a plurality of rules relating to the signals indicating the presence or absence of a fault and the associated indication of direction of the current of each protection device in the vicinity of the monitoring point, the vicinity being formed of the protection devices directly connected to this monitoring point. For each monitoring point, the fault condition is defined by cumulative rules: for each of the protection devices in the vicinity of the monitoring point, there is either: the detection of the presence of a fault, in the direction going towards the monitoring point or the absence of fault detection.

The steps 20 and 22 are preliminary steps carried out once for a given electricity distribution network.

The method furthermore comprises a monitoring 24 of the confirmation of a fault condition, at each monitoring point, depending on the signals indicating the presence or absence of a fault and the associated indication of direction of the current supplied by the protection devices in the vicinity of the monitoring point.

The monitoring is carried out by each of the protection devices by virtue of the installation of a hard-wired logic within the protection devices such as described hereinabove, or by a dedicated programming of an electronic card.

In the case of confirmation of a fault condition (test at the step 26, response “yes”), the method comprises a command 28 for tripping the opening of one or more protection devices and, more specifically, of each protection device in the vicinity of the monitoring point at fault and which supplies the fault current.

For example, when the presence of a fault is detected, each protection device starts a nominal timer of predetermined duration, e.g. 300 ms, then verifies the fault condition or conditions associated with the monitoring points, the vicinity of which the protection device forms a part. When one of the fault conditions is confirmed, then the duration of the trip timer is shortened to a timer duration T₁ less than T₀, which causes the tripping of the protection device before the expiry of the nominal timer duration of 300 ms.

1. A method for protecting an electrical distribution network comprising at least two sources of electrical energy, at least two connection bars, a plurality of loads to be supplied being respectively connected to one or the other of the connection bars, protection devices being connected, on at least one electrical conductor, between the sources (41, 42, 43, 44) and the loads, the electrical current flowing either in a first direction of current flow from the sources towards the loads, or in a second direction of current flow from the loads towards the sources, each protection device being configured to go from a closed state to an open state, the flow of electrical current in said at least one conductor being interrupted when the protection device is in the open state, each protection device having a nominal trip timer and being further configured to supply a signal of detection of a fault current indicating the presence or absence of a fault detected on an associated conductor depending on a current amplitude, and an indication of the direction of the fault current,
the method comprising:
determining a plurality of monitoring points within the distribution network, comprising at least one monitoring point directly connected to a plurality of protection devices, forming a vicinity of said monitoring point,
for each monitoring point, determining a fault condition, said fault condition being defined by a plurality of rules relating to the signals indicating the presence or absence of a fault and the associated indication of direction of the current for each protection device in the vicinity of said monitoring point,
monitoring a confirmation of a fault condition, and when a fault condition associated with a monitoring point is confirmed, tripping as a priority, with a trip timer less than the nominal trip timer, the opening of at least one of the devices for monitoring the vicinity of said fault point.

2. The method according to claim 1, in which, when the fault condition associated with a monitoring point is confirmed, all the protection devices in the vicinity of said monitoring point which supply said monitoring point with current are tripped as a priority.

3. The method according to claim 1, in which said rules are implemented in the form of hard-wired logic, in such a manner as to trip said at least one protection device forming part of the vicinity of a monitoring point when all of the rules forming the fault condition associated with said monitoring point are confirmed.

4. The method according to claim 1, in which, for a monitoring point, at least one rule associated with a protection device in the vicinity combines the presence of a detected fault with an associated fault direction or the absence of a detected fault.

5. The method according to claim 4, in which the absence of a detected fault is also representative of a state of opening of said protection device.

6. The method according to claim 1, in which, for each monitoring point, the associated fault condition is defined by the following cumulative rules: for each of the protection devices in the vicinity of said monitoring point, there is either: the detection of the presence of a fault, the direction of the fault current being in the direction of said monitoring point, or the absence of fault detection.

7. A system for protecting an electrical distribution network comprising at least two sources of electrical energy, at least two connection bars, a plurality of loads to be supplied being respectively connected to one or the other of the connection bars, protection devices being connected, on at least one electrical conductor, between the sources and the loads, the electrical current flowing either in a first direction of current flow from the sources towards the loads, or in a second direction of current flow from the loads towards the sources, each protection device being configured to go from a closed state to an open state, the flow of electrical current in said at least one conductor being interrupted when the protection device is in the open state, each protection device having a nominal trip timer and being further configured to supply a signal of detection of a fault current indicating the presence or the absence of fault detected on an associated conductor depending on a current amplitude, and an indication of the direction of the fault current,
the system being configured to:
determine a plurality of monitoring points within the distribution network, comprising at least one monitoring point directly connected to a plurality of protection devices, forming a vicinity of said monitoring point,
for each monitoring point, determine an associated fault condition, said fault condition being defined by a plurality of rules relating to the signals indicating the presence or absence of a fault and the associated indication of direction of the current of each protection device in the vicinity of said monitoring point,
monitor a confirmation of a fault condition, and when a fault condition associated with a monitoring point is confirmed, trip as a priority, with a trip timer less than the nominal trip timer, the opening of at least one of the devices for monitoring the vicinity of said fault point.

8. The system according to claim 7, in which the monitoring of confirmation of a fault condition is effected by a hard-wired logic, each protection device being configured to verify one or more fault conditions, each fault condition being associated with a monitoring point of the vicinity to which said protection device belongs.

9. The system according to claim 8, in which each given protection device, belonging to a vicinity of a monitoring point, receives at the input, via connection cables, the signals indicative of the presence of a fault current and indicative of the direction of the current of each other protection device belonging to said vicinity of said monitoring point, each of said signals being a binary signal.

10. The system according to claim 9, in which, within each protection device, the confirmation of the fault condition associated with said monitoring point is implemented, based on said binary signals received at the input, by means of internal relays of the protection device.

11. The system according to claim 8, in which, within each protection device, the confirmation of the fault condition associated with said monitoring point is implemented by logic gates.
